(19) United States
(12) Patent Application Publication
(10) Pub. No.: US 2020/0338668 A1
(43) Pub. Date: Oct. 29, 2020

(54) METHOD AND APPARATUS FOR LASER BEAM WELDING

(71) Applicant: Saipem S.p.A, Milan (IT)

(72) Inventors: Adriano Calzavara, San Donato Milanese Milan (IT); Davide Rossin, San Donato Milanese Milan (IT); Alessandro Bailini, Milano (IT)

(73) Assignee: Saipem S.p.A., Milan (IT)

(21) Appl. No.: 15/998,660

(22) PCT Filed: Feb. 16, 2017
(86) PCT No.: PCT/EP2017/053543

§ 371 Date: Aug. 16, 2018

(30) Foreign Application Priority Data
Feb. 16, 2016 (GB) 1602730.2

(51) Int. Cl. B23K 26/282; B23K 13/01

(52) U.S. Cl. CPC B23K 26/282; B23K 2101/10; B23K 13/01

(57) ABSTRACT

A method of laser beam welding two pipes together, the method including the steps of arranging two pipes such that a gap is provided between opposed surfaces of the pipes, heating at least one of the pipes by induction heating while the gap is provided between the opposed surfaces of the pipes, and subsequently laser beam welding the opposed surfaces of the pipes together.

### FIELD OF THE INVENTION

The present invention concerns a method and apparatus for welding pipes together using laser beam welding. More particularly, but not exclusively, this invention concerns laser beam welding pipes together when laying underwater pipelines. The invention also concerns a method of constructing a pipeline and particularly, but not exclusively, a method of constructing an underwater pipeline. The invention also concerns a pipe welding apparatus. The invention also concerns a pipeline construction apparatus.

### BACKGROUND OF THE INVENTION

When laying a pipeline at sea it is customary to weld, on a lay-barge, individual pipe sections to a pipe string (the pipe string leading towards the seabed). The welding process takes place close to the surface of the water. The pipe sections may consist of a plurality of pipe lengths each welded together on the laybarge to form the pipe sections when required.

A known process of welding pipes together is GMAW (gas metal arc welding), in which an electric arc is formed between a consumable wire electrode and adjacent surfaces of the pipes, to melt the surfaces and join them together. A shielding gas shields the process from contaminants in the air. GMAW includes MAG (metal active gas) welding and MIG (metal inert gas) welding.

However time is a critical factor in off-shore pipe laying, with delays in the laying, or refurbishment, of a pipeline resulting in significant additional expense due to the revenue lost from the pipeline being out of action. Current methods of welding an offshore pipeline, such as GMAW, are relatively slow.

In on-shore applications, specifically the automobile industry, laser beam welding is used to provide a relatively high speed welding process. However, due to the relatively high power density of laser beam welding, and the relatively small volume of the heat affected zone (HAZ) needed for welding pipes, (a laser beam has a relatively narrow focus), this results in a relatively high rate of post-weld cooling of the HAZ.

This high rate of cooling can result in defects in the welded material. For example, when steel is laser beam welded, the subsequent high rate of cooling can cause the formation of Martensite which can result in the formation of cracks in the material, as it cools.

In order to try and mitigate this problem, U.S. Pat. No. 6,365,866 (Brenner et al) discloses a method of laser welding engineering components of hardenable steel, where the components are pre-heated by induction heating, so as to reduce the hardening and subsequent crack formation that would otherwise occur. However, the induction pre-heating requires a relatively large amount of energy. The applicant has identified that, if this method were used for off-shore pipes (which have relatively thick walls, in order to withstand the pressures involved) then the amount of time required to weld pipes together would be too great. In this regard, the operational time of the pipeline that would be lost, due to the time required by the welding process, would result in an increase in costs that is prohibitively high.

The present invention seeks to address or mitigate at least some of the above mentioned problems. Alternatively, or additionally, the present invention seeks to provide an improved method of laser beam welding two pipes together. Alternatively, or additionally, the present invention seeks to provide an improved method of constructing a pipeline. Alternatively, or additionally, the present invention seeks to provide an improved pipe welding apparatus. Alternatively, or additionally, the present invention seeks to provide an improved pipeline construction apparatus.

### SUMMARY OF THE INVENTION

According to a first aspect of the invention there is provided a method of laser beam welding two pipes together, the method comprising the steps of arranging two pipes such that a gap is provided between opposed surfaces of the pipes, heating at least one of the pipes by induction heating while the gap is provided between the opposed surfaces of the pipes, and subsequently laser beam welding the opposed surfaces of the pipes together.

The induction heating may reduce the temperature gradient across the, or each, pipe caused by the laser beam welding, that would otherwise occur, thereby reducing the rate of post-weld cooling. This may reduce an undesirable change in material properties. For example when the method is used to weld pipes of carbon steel, the induction pre-heating may reduce, or even eliminate, the hardening and subsequent crack formation that would otherwise occur during post-weld cooling.

It will be appreciated that the induction heating comprises applying an alternating magnetic field to the pipe such that eddy currents are induced in the pipe, that act to heat the pipe.

The applicant has identified that, due to a surface effect, the eddy currents may migrate to and flow along the opposed surface of the (or each) heated pipe that (together with the other opposed surface) defines the gap, thereby providing a more efficient induction heating that is less reliant on conduction through the pipe (which is a relatively slow and inefficient means of heat transfer).

This may increase the rate of heating and/or reduce the energy required by the heating. This may also reduce the time required for a desired temperature distribution to be obtained. This is particularly advantageous in off-shore pipe welding, for example, in which the pipes are typically relatively thick and so would otherwise require a relatively large heating rate and/or amount of energy in order to pre-heat the pipes.

In addition the migration of the eddy currents to the, or each, opposed surface may reduce the size of the region of the, or each, pipe that is heated by the induction heating. This may prevent the heated pipe from interfering with subsequent production processes (e.g. non-destructive testing of the pipe). This is particularly advantageous in off-shore welding, for example, in which the pipe laying process is constrained by the operating conditions on a floating vessel.

The increased focusing of the heating may also allow for an increased level of control of the induction heating, with the actual heating of the pipe being more responsive to the applied heating. This may improve the weld quality.

Furthermore, this may allow the minimum cooling time required to be shortened, thereby allowing the next stage in an overall assembly process to be performed sooner (for example in a pipe laying process the next stage may be non-destructive testing of the pipe). This may provide for increased flexibility in the design of the overall assembly process. This is particularly advantageous in off-shore welding, for example, in which the design of the overall assembly process is constrained by the limitations of working on a floating vessel.

In embodiments of the invention the induction heating is applied in the region of the gap.

In embodiments of the invention the magnetic field passes into the gap.

In embodiments of the invention the gap is such that the eddy currents migrate to the opposed surface of the at least one pipe. Preferably the gap is substantially empty. Preferably there is no body located in the gap that electrically connects the opposed surfaces together.

Preferably there is no external body located in the gap that electrically connects the opposed surfaces together.

It will be appreciated that ‘external body’ refers to a body (i.e. a solid body) that is not part of either of the pipes (before the welding), for example to a filler metal body that forms part of the weld. In this respect optionally there is no body located in the gap that electrically connects the opposed surfaces together, where the body is not part of either of the pipes (i.e. not part of one or both of the pipes).

In embodiments of the invention the opposed surfaces are separated by the gap.

In embodiments of the invention the opposed surfaces are end surfaces of the pipes.

In embodiments of the invention the gap is an air gap.

Optionally one, or both, of the opposed surfaces extends in the radial direction.

It will be appreciated that, unless otherwise stated, references to the opposed surfaces are to the opposed surfaces prior to the surfaces being welded together.

Furthermore, it will be appreciated that, when the pipes are arranged end to end, they together define a longitudinal axis. References to an axial, radial or circumferential direction are relative to the longitudinal axis.

It will be appreciated that the laser beam welding is finished while the at least one pipe still contains heat from the induction heating.

Optionally each of the opposed surfaces is substantially aligned with a respective plane. Optionally each plane is substantially coplanar with a radial plane. Optionally the opposed surfaces are substantially parallel to each other.

Optionally each of the opposed surfaces is an annular surface that extends circumferentially substantially around the longitudinal axis of the pipes.

Optionally the gap extends in the axial direction.

Optionally the gap has a length, in the axial direction, that is greater than or equal to 0.05 mm, preferably greater than or equal to 0.1 mm.

Optionally the gap has a length, in the axial direction, that is less than or equal to 1 mm, preferably less than or equal to 0.5 mm, more preferably less than or equal to 0.3 mm.

The gap may have a length in the axial direction that is less than 0.5 mm.

Preferably the gap has a length, in the axial direction, that is greater than or equal to 0.05 mm and less than or equal to 0.5 mm.

Preferably the gap has a length, in the axial direction, that is greater than or equal to 0.1 mm and less than or equal to 0.3 mm.

Optionally the gap extends in the radial direction. The gap may extend partially, or substantially along, the radial length of one or both of the opposed surfaces.

The gap may circumferentially extend partially, or substantially, around the longitudinal axis of the pipes.

One, or both, of the opposed surfaces may form a section of a larger end surface of the respective pipe.

One, or both, of the opposed surfaces may form substantially an entire end surface of the respective pipe.

A plurality of gaps may be provided between the opposed surfaces of the pipes. Each gap may be provided between respective opposed sections of the opposed surfaces. It will be appreciated that, in this case, each of the opposed sections are welded to each other by the laser beam welding.

The plurality of gaps may be distributed in the circumferential and/or radial direction. One or both of the opposed surfaces may have a rough surface such that when discrete sections of the opposed surfaces are in contact, other discrete sections are spaced apart by respective gaps.

Optionally the pipes are retained in said arrangement during the induction heating.

Optionally the pipes are retained in their relative positions during the laser beam welding. It will be appreciated that the welding of the opposed surfaces together acts to remove the gap that was between them. In this regard, thermal effects and/or tolerances may allow the opposed surfaces to be welded together despite the pipes being retained in said arrangement.

Optionally the opposed surfaces are spaced apart by a spacer, to provide the gap.

The spacer may provide a way of accurately positioning the opposed surfaces of the pipes, to provide the gap, and of maintaining the gap during the induction pre-heating. This is particularly advantageous when welding pipes for an underwater pipeline, on a floating vessel, since harsh operating conditions on the vessel could otherwise make it difficult to accurately position the pipes.

The spacer may provide material, between the opposed surfaces, that forms part of the weld.

Optionally the opposed surfaces are spaced apart by a spacer, to provide the gap, and the opposed surfaces are substantially parallel to each other.

Optionally a pipe is provided with the spacer. The spacer may extend in the axial direction from the opposed surface of the pipe. The spacer may be part of the pipe. The spacer may be attached to, or integrally formed with, the pipe. The spacer may extend circumferentially substantially around the longitudinal axis of the pipe. Optionally each pipe is provided with a respective said spacer.

Optionally the gap is provided between the opposed surfaces of the pipes by positioning the pipes such that the spacers are in abutment with each other.

Optionally during the laser beam welding the, or each, spacer forms part of the weld.

Optionally the induction heating is of the heat affected zone of the at least one pipe. Pre-heating a region inside the heat affected zone may reduce the temperature gradient, across the heat affected zone, caused by the laser beam welding, thereby reducing the rate of cooling, following the welding. Accordingly this may reduce, or even eliminate, an undesirable change in material properties that would otherwise occur during the post-weld cooling.

Alternatively, or additionally, the induction heating is applied to a region of the at least one pipe that is outside of the heat affected zone. It will be appreciated that the region, outside of the heat affected zone, is commonly referred to in the art as the ‘base material’.

Pre-heating the region outside of the heat affected zone may reduce the temperature gradient, across the at least one pipe, caused by the laser beam welding, thereby reducing the rate of cooling, following the welding. Accordingly this may reduce an undesirable change in material properties that would otherwise occur during the post-welding.

Optionally the method comprises mounting an induction heating apparatus on the at least one pipe and the induction heating is carried out by the induction heating apparatus. The induction heating apparatus may be mounted on one or both of the pipes. Where the induction heating apparatus is mounted on one of the pipes, the induction heating apparatus may be mounted on one side of the gap only.

Where the induction heating apparatus is mounted on only one of the pipes, it may be arranged to heat only one of the pipes. Alternatively, it may be arranged to heat both of the pipes. In this case, in addition to the heating of the pipe that the induction heater is mounted on, there may be some inevitable induction heating of the other pipe, due to the magnetic field of the induction heater extending into the other pipe.

Optionally both pipes are heated by the induction heating. Optionally the induction heating is applied to regions of the pipes on opposite sides of the gap.

In embodiments of the invention the induction heating is applied to both pipes and the gap is such that the eddy currents migrate to the opposed surface of each pipe.

In embodiments of the invention the, or each pipe, is made of a material that is heatable by induction heating. In embodiments of the invention the, or each, pipe is made of a ferrous material. Optionally the, or each, pipe is made of a metal.

Optionally the, or each, pipe is made of steel. Optionally the, or each, pipe is comprised of steel. The steel may be carbon steel or alloy steel. The alloy steel may be a low-alloy steel.

In embodiments of the invention the, or each, pipe is made of a hardenable steel. Optionally the steel has a carbon content greater than or equal to 0.002%. Optionally the steel has a carbon content greater than or equal to 0.01%. Optionally the steel has a carbon content less than or equal to 0.5%. Optionally the steel has a carbon content less than or equal to 0.25%.

The pipe may be a multi-layer pipe, for example a clad pipe. Optionally the, or each, pipe comprises a plurality of metal layers, at least one of which optionally being of steel. Optionally the, or each, pipe comprises a metal layer, optionally a steel layer, provided with a coating. The coating may be a protective coating, for example an anti-corrosion coating. Alternatively or additionally the, or each, pipe may be provided with a coating configured to provide negative buoyancy to the pipe.

Optionally the pipes are for transporting oil or gas.

The pipes may have a size and wall thickness suitable for use as part of an underwater pipeline.

Optionally the pipes are for use at relatively large depths underwater.

It will be appreciated that each pipe comprises an annular wall. Optionally the walls of the pipes are relatively thick. Optionally the wall of each pipe has a thickness that is greater than or equal to 10 mm. Optionally the wall of each pipe has a thickness that is greater than or equal to 15 mm. Optionally the wall of each pipe has a thickness that is greater than or equal to 20 mm.

Optionally the wall of each pipe has a thickness that is less than or equal to 50 mm. Optionally the wall of each pipe has a thickness that is less than or equal to 40 mm. Optionally the wall of each pipe has a thickness that is less than or equal to 30 mm.

Optionally the wall of each pipe has a thickness that is greater than or equal to 10 mm and less than or equal to 50 mm.

Optionally the wall of each pipe has a thickness that is greater than or equal to 15 mm and less than or equal to 40 mm.

Optionally each pipe has a diameter that is greater than or equal to 400 mm. Optionally each pipe has a diameter that is greater than or equal to 600 mm. Optionally each pipe has a diameter that is less than or equal to 1,300 mm.

Optionally each pipe has a (outer) diameter that is greater than or equal to 400 mm and less than or equal to 1,300 mm.

Optionally the laser beam welding is effected by a laser beam welder arranged to travel relative to the pipes in the circumferential direction.

The laser beam welder may travel around the pipes in the circumferential direction to provide said relative motion. Alternatively, or additionally, the pipes may be rotated to provide said relative motion.

Optionally the heating of the at least one pipe is by at least one induction heater arranged to travel relative to the at least one pipe in the circumferential direction so as to heat the at least one pipe.

The at least one induction heater may travel around the at least one pipe in the circumferential direction to provide said relative motion. Alternatively, or additionally, the at least one pipe may be rotated to provide said relative motion.

The at least one induction heater may be arranged to heat the at least one pipe from outside the pipe. The at least one induction heater may be annular and extend in the circumferential direction around the outside of the at least one pipe. The at least one induction heater may be arranged to heat the at least one pipe uniformly in the circumferential direction.

The at least one induction heater may be arranged to heat the at least one pipe from inside the pipe. The at least one induction heater may be annular and extend in the circumferential direction around the inside of the at least one pipe. The at least one induction heater may be arranged to heat the at least one pipe uniformly in the circumferential direction.

The at least one induction heater may be mounted on, or in, the at least one pipe such that it is stationary relative to the at least one pipe, in the circumferential direction, as it heats the at least one pipe.

The at least one induction heater may be a plurality of induction heaters. In this case, optionally the heating of the at least one pipe is by a plurality of induction heaters arranged to travel relative to the at least one pipe in the circumferential direction. The induction heaters may be arranged to move with each other, or independently of each other.

Optionally the plurality of induction heaters are mounted on an annular carriage that extends in the circumferential direction around the at least one pipe and is arranged to rotate around the at least one pipe.

Optionally the heating of the at least one pipe is by a plurality of circumferentially distributed induction heaters and the laser beam welding is by a laser beam head, arranged to travel relative to the pipes in the circumferential direction, wherein each induction heater is turned on or off in dependence on the circumferential position of the laser beam head relative to the induction heater.

Optionally each induction heater is turned on as the laser beam head nears the induction heater, as it approaches the induction heater in the circumferential direction.

Optionally each induction heater is only on when the laser beam head is local to the induction heater, i.e. at or near the induction heater.

Optionally each induction heater is off when the laser beam head is remote from the induction heater, i.e. not at or near the induction heater.

Optionally once the laser beam head passes each induction heater in the circumferential direction, the induction heater is switched off.

Alternatively each induction heater may remain on, once the laser beam head passes the induction heater, to heat regions of the pipes after the welding.

Optionally at least one of the pipes is heated after the welding, so as to reduce the rate of cooling of the pipe. This may further reduce an undesirable change in material properties that would otherwise occur during the post-weld cooling.

Optionally both pipes are heated after the welding, so as to reduce the rate of cooling of the pipes.

Optionally the heating after the welding is by induction heating. Optionally the heating after the welding is by conduction heating.

Optionally the opposed surface of one or both pipes is machined such that the gap is provided between the opposed surfaces when the pipes are placed in said arrangement.

Optionally substantially no material is introduced between the opposed surfaces, during the laser beam welding, to form part of the weld.

Optionally substantially no external material is used to form part of the weld.

Optionally substantially no external material is introduced between the opposed surfaces, during the laser beam welding, to form part of the weld. Optionally substantially no external material is located between the opposed surfaces, during the laser beam welding, to form part of the weld.

It will be appreciated that ‘external material’ refers to material that is not part of either of the pipes (before the welding), for example to external welding filler material that forms part of the weld.

In this respect optionally substantially no material is used to form part of the weld, that is not part of either of the pipes (i.e. not part of one or both of the pipes). Optionally substantially no material is introduced between the opposed surfaces, during the laser beam welding to form part of the weld, that is not part of either of the pipes. Optionally substantially no material is located between the opposed surfaces, during the laser beam welding to form part of the weld, that is not part of either of the pipes.

The heating of the at least one pipe by induction heating may be from outside the pipe. The heating of the at least one pipe by induction heating may be from inside the pipe.

The laser beam welding may be laser-hybrid welding. In this respect, the laser beam welding may be performed in conjunction with gas metal arc welding (e.g. semi-automatic gas metal arc welding). Preferably the laser beam welding is not laser-hybrid welding.

It will be appreciated that one or both of the pipes may be heated, by induction heating, before the pipes are arranged such that the gap is provided between their opposed surfaces. However, preferably the pipes are arranged such that the gap is provided between their opposed surfaces before the pipes are heated by induction heating.

Preferably the induction heating is stopped before the laser beam welding is started. However, the induction heating of the, or each, pipe may continue during the laser beam welding.

It will be appreciated that, once the laser beam welding has finished, the regions of the pipes that were heated by the welding cool down by losing their heat to the surroundings.

According to a second aspect of the invention there is provided a method of constructing a pipeline comprising laser beam welding two pipes together according to the method of the first aspect of the invention, to form a pipeline.

If the method is used to weld a pipe section to a pipeline, one of the two pipes will be the pipe section and the other will be the free end of the pipeline to which the pipe section is to be connected.

The method may be used to weld together two pipe lengths (or more, in series) to form a pipe section.

The method may comprising laser beam welding a plurality of pairs of pipes together, according to the method of the first aspect of the invention, to form a pipeline.

Optionally the pipeline is an underwater pipeline and the method comprises deploying the pipeline into an underwater position.

Optionally the welding of the pipes is performed on a support surface located on the water. The support surface may be floating on the water. The support surface may be part of a floating vessel. The welding of the pipes may be performed on a laybarge.

The pipeline may be deployed into its underwater position by the J-lay method, S-lay method and/or tow-in method.

If the method is used to connect a pipe section to a pipe string (the pipe string leading towards the seabed), one of the two pipes will be the pipe section and the other will be the free end of the pipe string to which the pipe section is to be connected.

According to a third aspect of the invention there is provided a pipe welding apparatus configured to carry out a method of laser beam welding two pipes together according to the first aspect of the invention.

According to a fourth aspect of the invention there is provided a pipeline construction apparatus configured to carry out the method of constructing a pipeline according to the second aspect of the invention.

The pipeline construction apparatus may comprise a support surface located on the water, for supporting the pipes as they we welded together.

The support surface may be floating on the water. The support surface may be part of a floating vessel. The apparatus may comprise the floating vessel. The floating vessel may be a laybarge.

According to a fifth aspect of the invention there is provided a pipe having an end that has been machined such that the pipe is for use in a method of laser beam welding according to the first aspect where, in the method, the opposed surfaces are spaced apart by said spacer, to provide the gap when the pipes are in said arrangement.

According to a sixth aspect of the invention there is provided a combination of first and second pipes that each have an end that has been machined such that the pipes are for being welded together by a method of laser beam welding according to the first aspect of the invention where, in the method, the opposed surfaces are spaced apart by said spacer, to provide the gap when the pipes are in said arrangement.

According to a seventh aspect of the invention there is provided a combination of first and second pipes that each have an end that has been machined such that the pipes are for being welded together by a method of laser beam welding according to the first aspect of the invention, wherein the combination further comprises a pipe welding apparatus according to the third aspect of the invention.

According to an eighth aspect of the invention there is provided a combination of first and second pipes that each have an end that has been machined such that the pipes are for being welded together by a method of laser beam welding according to the first aspect of the invention, wherein the combination further comprises a pipeline construction apparatus according to the fourth aspect of the invention.

It will of course be appreciated that features described in relation to one aspect of the present invention may be incorporated into other aspects of the present invention. For example, the method of any aspect of the invention may incorporate any of the features described with reference to the apparatus of any aspect of the invention and vice versa.

Other preferred and advantageous features of the invention will be apparent from the following description.

### DESCRIPTION OF THE DRAWINGS

Embodiments of the present invention will now be described by way of example only with reference to the accompanying schematic drawings of which:

FIG. 1 shows a radial cross-sectional view of ends of first and second pipes that are for welding together by a method of laser beam welding according to an embodiment of the invention, with the pipes arranged end to end;

FIG. 2 shows a perspective view of the pipes shown in FIG. 1, with a welding apparatus according to an embodiment of the present invention, for carrying out a method of laser beam welding according to embodiments of the invention, mounted on one of the pipes;

FIG. 3 shows a perspective view corresponding to that of FIG. 2, but where the view is from a different angle;

FIG. 4 shows a perspective view corresponding to that of FIG. 3, but where a housing of each induction heater of the welding apparatus is shown as transparent, for illustrative purposes;

FIG. 5 shows an enlarged view of the region labelled ‘A’ in FIG. 1, but also showing the position of the induction heaters, of the welding apparatus shown in FIG. 2, on the pipes;

FIG. 6 shows a view corresponding to that of FIG. 5, but where the pipes 1, 2 are for welding together by a method of laser beam welding according to a further embodiment of the invention;

FIG. 7 shows a view corresponding to that of FIG. 6, but where the pipes 1, 2 are for welding together by a method of laser beam welding according to a further embodiment of the invention;

FIG. 8 shows the magnetic vector potential field [Wb/m] during induction heating, on a view corresponding to FIG. 7 but where the end surfaces of the pipes are in contact when they are induction heated and with the welding apparatus omitted for illustrative purposes;

FIG. 9 shows the magnetic vector potential field [Wb/m] during induction heating, on a view corresponding to FIG. 7, where the end surface of the pipes are spaced apart by a gap when they are induction heated and with the welding apparatus omitted for illustrative purposes;

FIG. 10 shows a view corresponding to that of FIG. 4 but where the welding apparatus is according to a further embodiment of the invention;

FIG. 11 shows a view corresponding to that of FIG. 4 but where the welding apparatus is according to a further embodiment of the invention;

FIG. 12 shows a view corresponding to that of FIG. 4 but where the welding apparatus is according to a further embodiment of the invention;

FIG. 13 shows a view corresponding to that of FIG. 4 but where the welding apparatus is according to a further embodiment of the invention, where end sections of the pipes are cut away for illustrative purposes, and

FIG. 14 shows a schematic view of a pipeline construction apparatus according to a further embodiment of the invention.

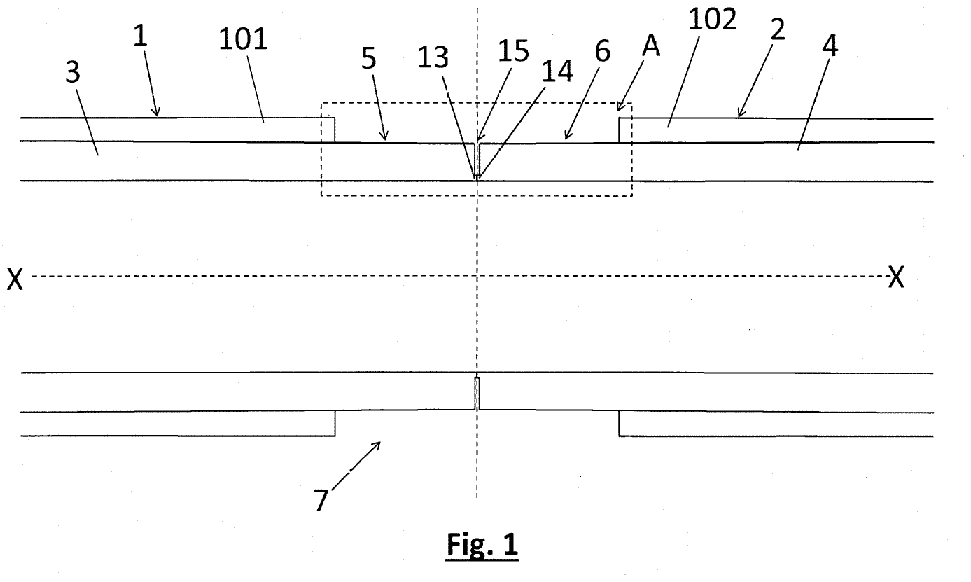

It will be appreciated that FIGS. 1, 5, 6 and 7 are not to scale, with the size of the gap 15, and of the spacer(s), exaggerated in order to make it easier to identify features in the Figures.

### DETAILED DESCRIPTION

Referring to FIG. 1 there is shown a cross-sectional view of ends of first and second pipes 1, 2 that are to be welded together by a method according to an embodiment of the invention.

Each pipe 1, 2 has the shape of a hollow right circular cylindrical tube that extends along a longitudinal axis. Each pipe 1, 2 comprises an annular wall 3, 4 that extends circumferentially about the respective longitudinal axis of the pipe 1, 2.

In a method of laser beam welding according to an embodiment of the invention the pipes 1, 2 are arranged end to end (as described in more detail below). In this position the longitudinal axes of the pipes 1, 2 are substantially co-axial, to define a common longitudinal axis X.

It will be appreciated that, unless otherwise stated, references to an axial, radial or circumferential direction are relative to the longitudinal axis X.

Each pipe 1, 2 is provided with an outer coating 101, 102 that comprises a inner layer of an anti-corrosion coating, for example an epoxy coating, and an outer layer of reinforced concrete, configured to provide protection and negative buoyancy to the pipes 1, 2. Such a coating is well known in the art and will not be described in any further detail.

The coating 101, 102 at adjacent ends 5, 6 of the pipes 1, 2 is cut away such that when the adjacent ends 5, 6 of the pipes 1, 2 are brought together they define a circumferentially extending annular groove 7.

Each pipe 1, 2 is made of a hardenable steel. In this regard, each pipe is made of steel with a carbon content of 0.2%.

In the described embodiment the pipes 1, 2 are for use as part of an underwater pipeline, for use at relatively large depths underwater. In this regard, the walls 3, 4 of the pipes are relatively thick. In the currently described embodiment the wall 3, 4 of each pipe 1, 2 has a thickness of 30 mm.

Each pipe 1, 2 has an external diameter of 406.4 mm (16 inches).

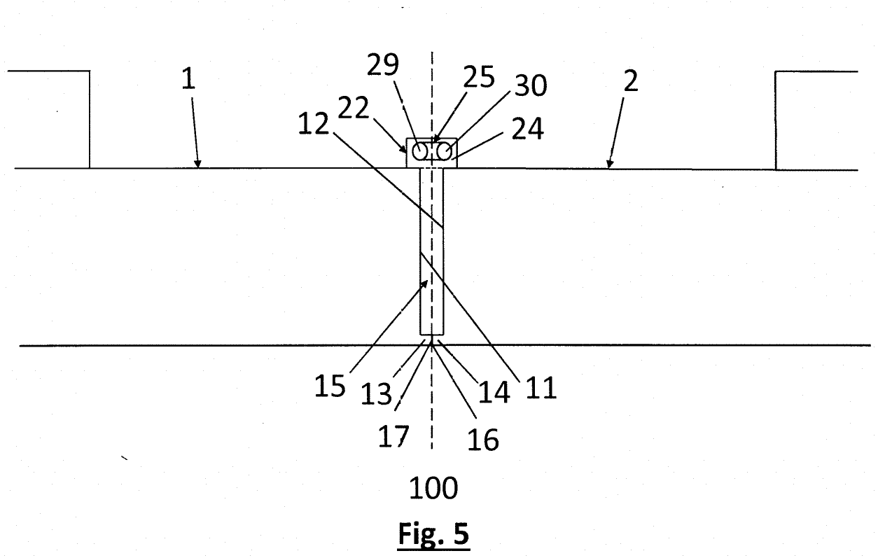

The adjacent pipe ends 5, 6 have opposed end surfaces 11, (see FIG. 5). Each end surface 11, 12 is an annular ring that extends substantially around the longitudinal axis X. Each end surface 11, 12 is substantially aligned with a respective radial plane, i.e. a plane that is substantially perpendicular to the longitudinal axis X. In this regard, the end surfaces 11, 12 are substantially parallel to each other.

As best seen in FIG. 5, the ends 5, 6 of the pipes 1, 2 are each provided with a spacer 13, 14. Each spacer 13, 14 extends in the axial direction away from the respective end surface 11, 12 (towards the other end surface). Each spacer 13, 14 is annular and extends substantially around the longitudinal axis X. Each spacer 13, 14 is provided radially inwardly of the respective end surface 11, 12. Each spacer 13, is integrally formed with the respective pipe 1, 2. In this regard, each spacer 13, 14 is part of the respective pipe 1, 2.

Each spacer 13, 14 has a respective end surface 16, 17. The end surfaces 16, 17 are opposed to each other. Each end surface 16, 17 is an annular ring, extending substantially around the longitudinal axis X. Each end surface 16, 17 is substantially aligned with a respective radial plane, i.e. a plane that is substantially perpendicular to the longitudinal axis X. In this regard, the end surfaces 16, 17 are substantially parallel to each other.

The pipes 1, 2 are positioned such that the facing end surfaces 16, 17 of the spacers 13, 14 are in abutment with each other, along an abutment interface 100.

The spacers 13, 14 are arranged such that, when their end surfaces 16, 17 are in abutment with each other, a gap 15 is provided between the end surfaces 11, 12 of the pipes 1, 2.

The gap 15 is annular, extending substantially around the longitudinal axis X. It will be appreciated that the gap 15 is defined by the end surfaces 11, 12 of the pipes 1, 2. In this regard, the gap 15 is the annular space between the end surfaces 11, 12 within the radial extent of the end surfaces 11, 12 (in FIG. 5 the radially outer extent of the gap 15 is shown as a dotted line).

The gap 15 extends in the axial direction X, extending from the end surface 11 of the first pipe 1 to the end surface 12 of the second pipe 2. The gap has a length, in the axial direction, of 0.2 mm.

The gap also extends in the radial direction, substantially along the radial length of each of the opposed end surfaces 11, 12. Substantially the entire areas of the opposed end surfaces 11, 12 are separated from each other by the gap 15.

The gap 15 is an air-gap. The gap 15 is an engineered gap. In this respect, the opposed surfaces 11, 12 of the pipes 1, 2 are machined such that when they are in the position shown in the Figures, the gap 15 is provided between the opposed surfaces 11, 12.

The gap 15 is substantially empty. There is no body located in the gap 15 that electrically connects the opposed surfaces 11, 12 together. It will be appreciated that the spacers 13, 14 are not located in the gap 15, but are part of the pipes 1, 2 respectively and the radially outer surfaces of the spacers 13, 14 define the radially inner side of the gap 15. As stated above, each spacer 13, 14 is provided radially inwardly of the end surfaces 11, 12 that define the gap 15.

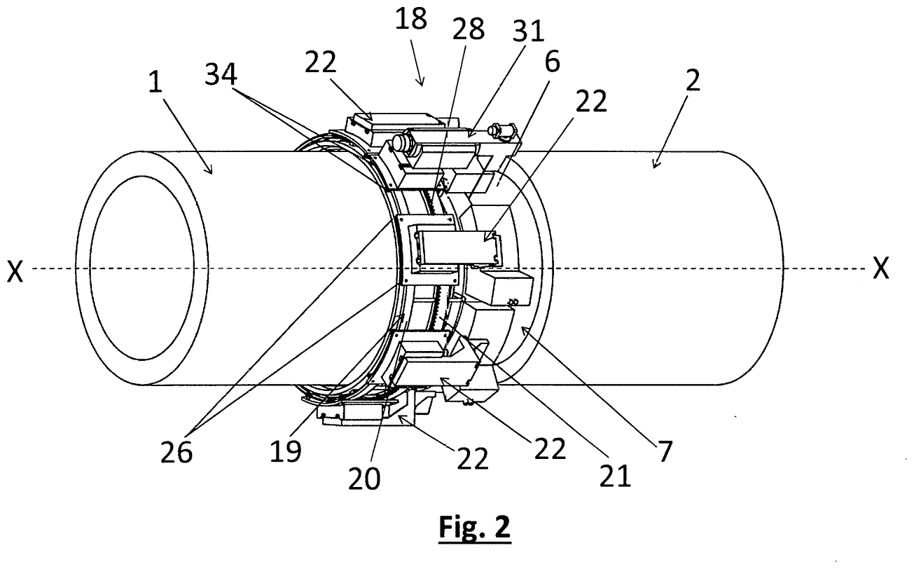

Referring to FIGS. 2 to 4 there is shown a welding apparatus 18, according to an embodiment of the invention, mounted on the first pipe 1. The welding apparatus 18 is for welding the pipes 1, 2 together.

The welding apparatus 18 comprises a track 19 that is fixedly mounted as a single unit on the first pipe 1. The track 19 extends circumferentially around the pipe 1.

The track 19 comprises an outboard rail 20 and an inboard rail 21 that are axially spaced apart. It will be appreciated that, unless otherwise stated, references to ‘inboard’ and ‘outboard’, in respect of a pipe 1, 2, are in relation to the end surface 11, 12 of the respective pipe (i.e. if something on a pipe 1, 2 is inboard of something else, it is closer to the respective end surface 11, 12 of the pipe 1, 2 (and vice-versa)).

An outboard surface of the inboard rail 21 has a toothed surface that forms a rack 28 that extends along the circumferential length of the rail 21.

A plurality of induction heaters 22, in the form of four induction heaters 22, are mounted on the track 19 for movement along the track 19, in the circumferential direction. The induction heaters 22 are distributed circumferentially along the track 19.

Each induction heater 22 is substantially identical and corresponding features of each induction heater 22 are given the same reference numerals. For the sake of clarity, features of only one induction heater 22 are described below, but it will be appreciated that the other induction heaters 22 comprise corresponding features.

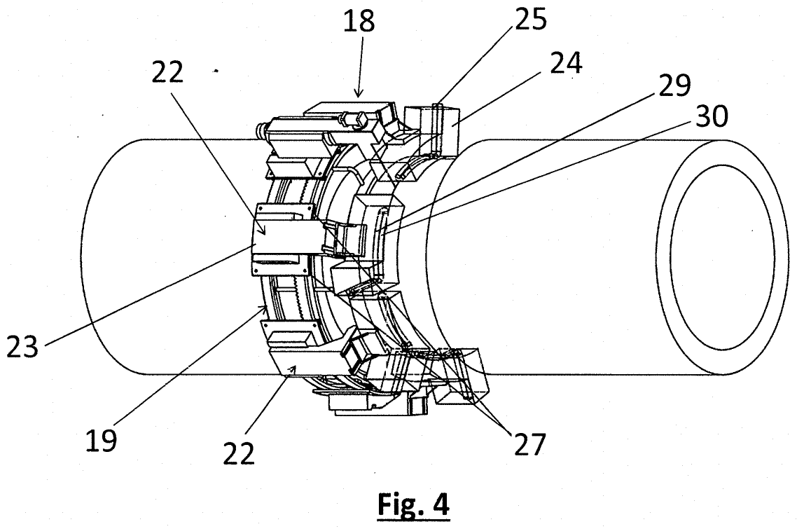

As best seen in FIG. 4 (in which the housing 24 of each induction heater is shown as transparent, for illustrative purposes), each induction heater 22 comprises a carriage 23, mounted on the track 19 for movement along the track 19 in the circumferential direction, a housing 24 mounted on the carriage 23 and an induction heating wire 25 provided in the housing 24.

Each carriage 23 is movably mounted on the track 19 by an outboard pair of circumferentially spaced rollers 26 (see FIG. 2), that are arranged to run along the outboard rail 20 and an inboard pair of circumferentially spaced rollers 27 (see FIG. 4), that are arranged to run along the inboard rail 21.

A pinion wheel (not shown) is rotatably mounted on each carriage 23, for engagement with the rack 28. The pinion wheel is connected, by a drive chain (not shown) to an actuator in the form of a stepper motor (not shown) located in the carriage 23. The rotation of the pinion wheel drives the respective carriage 23 along the track 19.

Each induction heater 22 is drivable around the track 19 independently of the other induction heaters 22.

The induction heating wire 25 is an electrically conductive wire that extends in the circumferential direction and is looped back on itself, at one end, such that it forms a pair of axially spaced, circumferentially extending, wire portions 29, 30 (see FIG. 4). First and second ends of the wire extend out of a side of the housing 24, where they are connected to a source of high-frequency alternating electric current (not shown).

The welding apparatus 18 is mounted on the pipe 1 such that each induction heater 22 extends across the axial extent of the gap 15 (see FIG. 5). In this respect, for each induction heater 22, the wire portions 29, 30 of the induction heating wire 25 are disposed on opposite axial sides of the abutment interface 100 and extend axially across that side of the gap 15.

Each induction heater 22 is arranged to heat respective sections of both pipes 1, 2 in the region of the gap 15. In this regard, for each induction heater 22, the alternating electric current in the induction heating wire 25 creates an alternating magnetic field that passes into the gap 15 and penetrates respective sections of the pipes 1, 2 on either side of the gap 15. This induces eddy currents in regions of the pipes 1, 2 on either side of the gap 15, proximal to the gap 15. This acts to heat the pipes 1, 2, as described in more detail below.

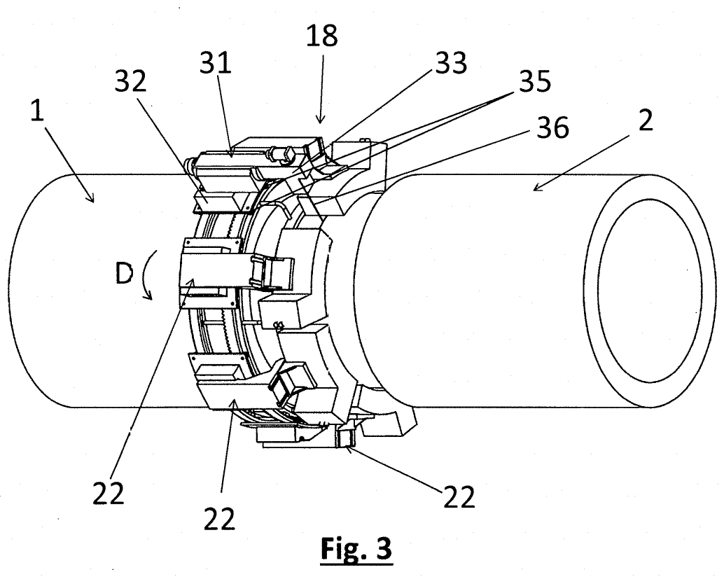

With reference to FIG. 3, the welding apparatus 18 further comprises a laser beam welder 31. The laser beam welder 31 comprises a carriage 32 and a laser beam head 33 that is mounted on the carriage 32. The laser beam welder 31 is connected to an energy source (not shown) to power the laser beam head 33.

The carriage 32 has a similar structure to the carriages of the induction heaters 22. In this regard the carriage 32, is mounted on the track 19 for movement along the track 19 in the circumferential direction, by an outboard pair of circumferentially spaced rollers 34 (see FIG. 2), that are arranged to run along the outboard rail 20 and an inboard pair of circumferentially spaced rollers 35 (see FIG. 3), that are arranged to run along the inboard rail 21.

A pinion wheel (not shown) is rotatably mounted on the carriage 32, for engagement with the rack 28. The pinion wheel is connected, by a drive chain (not shown) to an actuator in the form of a stepper motor (not shown) located in the carriage 32. The rotation of the pinion wheel drives the carriage 32 along the track 19.

The laser beam head 33 is positioned radially outwardly of the gap 15 and is axially aligned with the gap 15 such that as it is carried by the carriage 32, it travels circumferentially around the longitudinal axis X, welding the opposed end surfaces 11, 12 of the pipes 1, 2 together. In this regard, the laser beam head 33 emits a laser beam 36 (see FIG. 3) that is substantially in-line with the abutment interface 100 and the beam has a diameter of 0.3 mm, which is therefore wider than the gap 15.

The welding apparatus 18 further comprises a support frame (not shown) and a pair of clamps (not shown) mounted on, and fixedly attached to, the support frame. Each clamp is attached around a respective pipe 1, 2 to axially fix the pipes in their positions shown in FIGS. 1 to 7, to maintain the gap 15 between the opposed surfaces 11, 12 of the pipes 1, (prior to the welding).

A method of welding the two pipes 1, 2 together, according to an embodiment of the invention, using the above described welding apparatus 18, will now be described.

The pipes 1, 2 are arranged end to end such that the gap 15 is provided between the opposed end surfaces 11, 12 of the pipes 1, 2, as shown in FIG. 1.

In order to arrange the pipes 1, 2 in this position, the pipes 1, 2, are positioned such that the end surfaces 16, 17 of the spacers 13, 14 are in abutment with each other. In this position, the gap 15 is provided between the end surfaces 11, 12 of the pipes 1, 2.

The spacers 13, 14 provide a way of accurately positioning the opposed surfaces 11, 12 of the pipes 1, 2 to provide the gap 15, and of maintaining the gap 15 during the induction pre-heating (described in more detail below).

Each clamp is attached around a respective pipe 1, 2 to axially fix the pipes in their positions shown in FIGS. 1 to 7, to maintain the gap 15 between the opposed surfaces 11, 12 of the pipes 1, 2 (prior to the welding).

With the pipes 1, 2 in this position, the welding apparatus 18 is mounted on the first pipe 1, in the position shown in FIGS. 2 to 5 and as described above.

While the pipes 1, 2 are maintained in this position, with their end surfaces 11, 12 spaced apart by the gap 15, the four induction heaters 22 and the laser beam welder 31 are driven, by the respective stepper motors that they are connected to, to travel in the circumferential direction D (see FIG. 3), which is anti-clockwise when looking along the second pipe 2, towards the abutment interface 100. The induction heaters 22 and the laser beam welder 31 travel at substantially the same speed around the abutment interface 100.

Each of the induction heaters 22 and the laser beam welder 31 are on, as they travel around the abutment interface 100.

In this respect, the three induction heaters 22 that are located in front of the laser beam welder 31 (relative to the circumferential direction of movement of the laser beam welder 31) act to heat a region of each pipe 1, 2, on either side of the gap 15, that extends circumferentially ahead of the laser beam welder 31, before the laser beam welder 31 welds the opposed end surfaces 11, 12 of that region together.

This ‘induction pre-heating’ is of the ‘heat affected zone’, which is commonly known in the art as the region where the material properties of the pipe are (subsequently) affected by the heat from the laser welding.

The pipes 1, 2 are maintained in their relative positions, during the induction heating, by the clamps, such that the size of the gap 15 is substantially constant during this ‘induction pre-heating’.

The induction pre-heating reduces the temperature gradient across the pipes 1, 2 caused by the subsequent laser beam welding, thereby reducing the rate of cooling of the pipes 1, 2 following the welding. This may reduce, or even eliminate, the hardening of the steel pipes 1, 2 and subsequent crack formation that would otherwise occur during post-weld cooling.

The applicant has identified that the provision of the gap 15 is advantageous in that, due to a surface effect, the eddy currents migrate to the opposed end surfaces 11, 12 that define the gap 15, thereby providing a more efficient induction heating that is less reliant on conduction through the pipes 1, 2 (conduction is a relatively slow and inefficient means of heat transfer). This may also reduce the time required for a desired temperature distribution to be obtained.

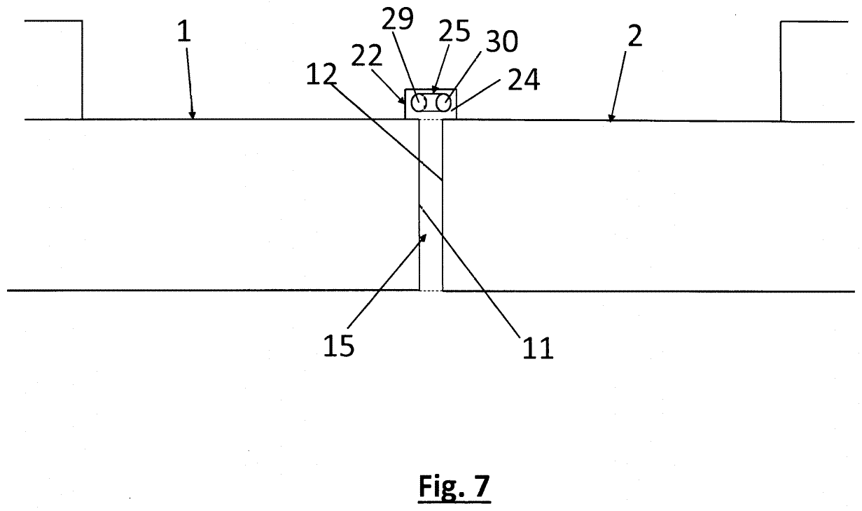

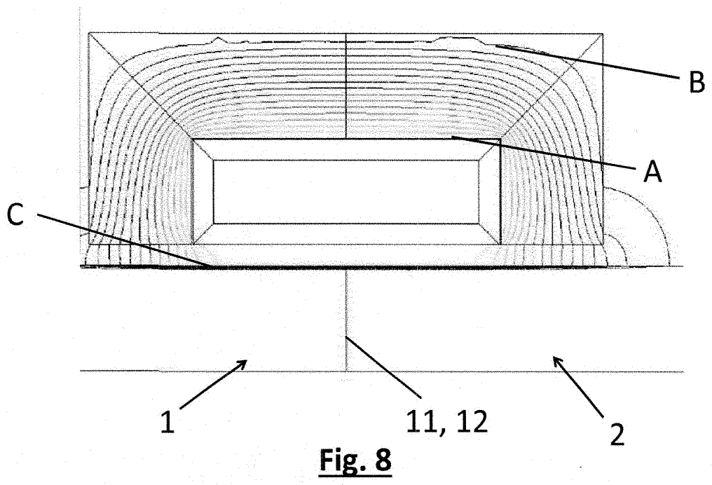

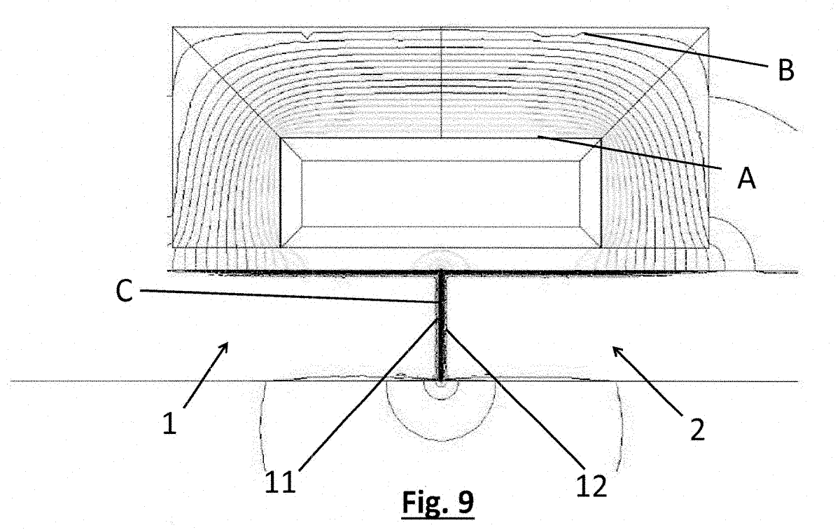

This is illustrated by FIGS. 8 and 9. FIG. 8 shows the magnetic vector potential field [Wb/m] during induction heating, on a view corresponding to FIG. 7 (a further embodiment of the invention where the pipes 1, 2 are not provided with spacers 13, 14 but are held in position such that their end surfaces 11, 12 are spaced apart by the gap 15 during induction heating, as discussed below) but where the end surfaces 11, 12 of the pipes 1, 2 are in contact when they are induction heated. In FIG. 8, the magnetic vector potential decreases from contour A, at approximately 3×10⁻³ (Wb/m) to contour B, at approximately 200×10⁻⁶ (Wb/m). The magnetic vector potential at position C, along the upper surface of the pipes 1, 2 is approximately 2×10⁻³ (Wb/m).

FIG. 9 shows the magnetic vector potential field [Wb/m] during induction heating, on a view corresponding to FIG. 7, i.e. where the end surfaces 11, 12 of the pipes 1, 2 are spaced apart by the gap 15 when they are induction heated. In FIG. 9, the magnetic vector potential field decreases from contour A, at approximately 2×10⁻³ (Wb/m) to contour B, at approximately 100×10⁻⁶ (Wb/m). The magnetic vector potential at position C, in the gap between the end surfaces 11, 12 of the pipes, is approximately 600×10⁻⁶ (Wb/m).

As shown in FIG. 0, when the end surfaces 11, 12 of the pipes 1, 2 are in contact when the ends of the pipes 1, 2 are induction heated, there is no magnetic potential field between the end surfaces 11, 12 (since the end surfaces 11, 12 are in contact). In contrast, as shown in FIG. 9, when the end surfaces 11, 12 of the pipes 1, 2 are spaced apart by the gap during induction heating, the magnetic vector potential field passes into the gap 15. Furthermore, there is a relatively high concentration of the magnetic vector potential field in the gap 15 between the end surfaces 11, 12.

This relatively high concentration of magnetic vector potential field in the gap 15 between the end surfaces 11, 12 results in the migration of eddy currents to the opposed end surfaces 11, 12, thereby providing a more efficient induction heating.

This effect is also produced by the induction heating of the other versions of the pipes 1, 2, when spaced apart by the gap 15, shown in the other Figures.

This increases the rate of heating and/or reduces the energy required by the induction heating. This is particularly advantageous in off-shore pipe welding, for example, in which the pipes are typically relatively thick and so would otherwise require a relatively large heating rate and/or amount of energy in order to pre-heat the pipes 1, 2.

In addition the migration of the eddy currents to the opposed surfaces 11, 12 of the pipes that are separated by the gap 15 reduces the size of the region of the, or each, pipe 1, 2 that is heated by the induction heating. This may prevent the heated pipes 1, 2 from interfering with subsequent production processes (e.g. non-destructive testing of the pipes 1, 2). This is particularly advantageous in off-shore welding, for example, in which the pipe laying process is constrained by the harsh operating conditions on a floating vessel.

The increased focusing of the heating may also allow for an increased level of control of the induction heating, with the actual heating of the pipe being more responsive, to the applied heating. This may improve the weld quality.

Furthermore, this may allow the minimum cooling time required to be shortened, thereby allowing the next stage in an overall assembly process to be performed sooner. This may provide for increased flexibility in the design of the overall assembly process. This is particularly advantageous in off-shore welding, for example, in which the design of the overall assembly process is constrained by the limitations of working on a floating vessel.

The spacers 13, 14, provide a way of accurately positioning the opposed end surfaces 11, 12 of the pipes 1, 2, to provide the gap 15, and of maintaining this gap during the induction pre-heating.

As the laser beam welder 31 follows the three induction heaters 22 in front of it, it welds the opposed end surfaces 11, 12 of the pipes 1, 2 together.

As the laser beam welder 31 travels in the circumferential direction D, its laser melts the opposed end surfaces 11, 12 of the pipes 1, 2, which causes them to join by fusing together.

As the pipes 1, 2 are welded together, the gap 15 between them is substantially removed. In this regard, it will be appreciated that thermal effects and/or tolerances allow the end surfaces to be welded together despite the pipes being held in their positions by the clamps of the welding apparatus 18.

The induction heaters 22 and the laser beam welder 31 travel around substantially the entire circumference of the pipes 1, 2, so that substantially the entire circumference of the end surfaces 11, 12 of the pipes 1, 2 are pre-heated and then welded together.

No external material is introduced between the opposed surfaces 11, 12, during the laser beam welding, to form part of the weld (such external material is introduced in conventional laser beam welding, to form part of the weld). No external material is used to form part of the weld.

However, the spacers 13, 14 provide material, between the opposed end surfaces 11, 12 that is melted by the laser and forms part of the weld. The melted material of the spacers 13, 14 fuses with the melted end surfaces 11, 12 of the pipes 1, 2, which facilitates joining the surfaces 11, 12 together.

Once the entire circumference of the pipes has been welded, the laser beam welding is stopped. Following the laser beam welding, the regions of the pipes 1, 2 that were heated by the welding cool down by losing their heat to the surroundings.

A single induction heater 22 is located behind the laser beam welder 31 (relative to the circumferential direction of movement of the laser beam welder 31) and acts to heat a region of each pipe 1, 2 on either side of the gap 15, that extends circumferentially behind the laser beam welder 31, after the laser beam welder 31 welds the opposed end surfaces 11, 12 of that region together. This ‘induction post-heating’ further reduces the rate of cooling of the pipes 1, 2 following the welding. This may reduce, or even eliminate, the hardening of the steel pipes 1, 2 and subsequent crack formation that would otherwise occur during post-weld cooling.

In an alternative version (not shown) of the above described embodiment of the welding apparatus 18, an internal clamp is provided in each pipe 1, 2 to clamp the pipes 1, 2 in place, from the inside, so as to axially fix the pipes 1, 2 in their spaced apart positions.

Furthermore, the track 19 is replaced with an annular carriage that extends circumferentially around the pipe 1 and comprises first and second circumferentially extending sections, with the laser beam welder 31 mounted on the first circumferential section and the induction heaters 22 mounted together on the second circumferential section. The second circumferential section extends from one end of the first circumferential section, around the pipe 1, to the other end of the first circumferential section. Accordingly, the induction heaters 22 are distributed circumferentially around the pipe 1, either side of the laser beam welder 31.

The carriage is rotatably mounted on the pipe 1, by wheels that run along the radially outer surface of the pipe 1, and is arranged to rotate around the pipe 1 and its internal clamp. In this regard, the carriage is coupled to a motor such that the motor rotatably drives the carriage around the pipe 1. The carriage is provided with a rack that engages with a pinion wheel driven by the motor so as to drive the carriage circumferentially around the pipe 1.

The laser beam welder 31 is fixedly mounted to the first circumferential section of the carriage such that, as the carriage rotates around the pipe 1, the laser beam welder 31 travels with the carriage around the pipe 1, so as to weld the end surfaces of the pipes 1, 2 together, in the same way as the above described embodiment. The speed and timing of the travel of the carriage is controlled so as to control the welding of the end surfaces of the pipes 1, 2.

Similarly, the induction heaters 22 are fixedly mounted to the second circumferential section of the carriage such that, as the carriage travels around the pipe 1, the induction heaters 22 perform the induction-post heating or induction pre-heating respectively, in the same way as in the above described embodiment. The speed and timing of the travel of the carriage is controlled so as to control the induction heating of the pipes 1, 2. The induction heaters 22 are arranged to heat inside the heat affected zone.

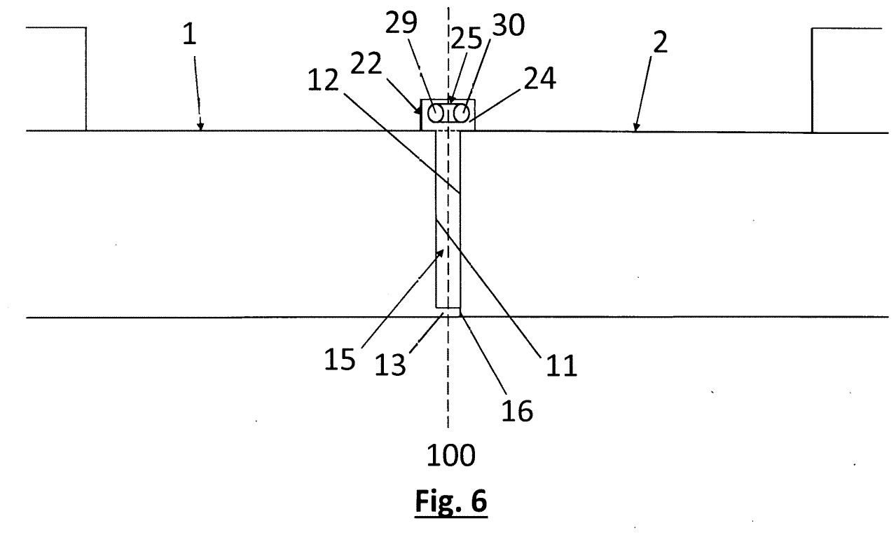

Different spacer arrangements may be used to that of the above described embodiment. In this regard, FIGS. 6 and 7 shows pipes 1, 2 that are for welding together by a method of laser beam welding according to further embodiments of the invention.

In FIGS. 6 and 7, the pipes 1, 2 and welding apparatus 18 are identical to those in FIGS. 1 to 5, except for the differences described below. Corresponding features are given corresponding reference numerals.

In the embodiment shown in FIG. 6 only the first pipe 1 is provided with a spacer 13. The second pipe 2 is not provided with a spacer. The spacer 13 is arranged such that when it abuts the end of the second pipe 2, the gap 15 is provided between the first and second end surfaces 11, 12 of the pipes 1, 2.

In any of the described embodiments the, or each, spacer 13, 14 may be attached to, or integrally formed with, the respective pipe 1, 2. The, or each, spacer 13, 14 may be part of the respective pipe 1, 2.

In the embodiment shown in FIG. 7, neither of the pipes 1, 2 are provided with a spacer. In this case, each of the pipes 1, 2 are held spaced apart by the clamps of the welding apparatus 18 to maintain the gap 15 between the end surfaces 11, 12 of the pipes 1, 2 during the induction pre-heating (prior to the welding).

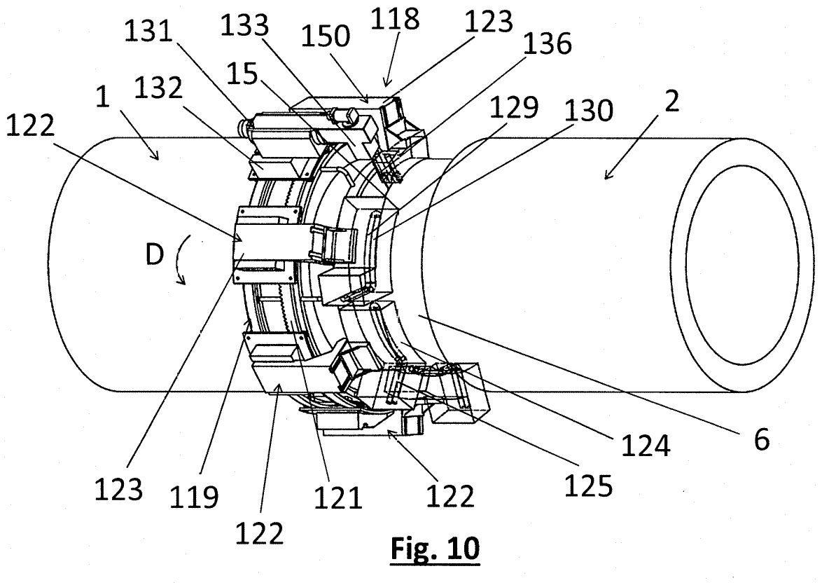

Referring to FIG. 10 there is shown a view corresponding to that of FIG. 4 but where the welding apparatus 118 is according to a further embodiment of the invention, and where a housing 124 of each induction heater 122 is shown as transparent, for illustrative purposes.

In FIG. 10 the pipes 1, 2 and welding apparatus 118 are identical to those in FIGS. 1 to 5, except for the differences described below. Corresponding features of the pipes 1, 2 are given corresponding reference numerals. Corresponding features of the welding apparatus are given corresponding reference numerals but incremented by 100.

The welding apparatus 118 is identical to the welding apparatus 18 except in that, for each induction heater 122, the induction heating wire 125 is located entirely on one side of the gap 15. In the described embodiment the induction heating wire 125 is located entirely on the same side of the gap 15 as the first pipe 1. In this regard, both the wire portions 129, 130 are located on the same side of the gap 15 as the first pipe 1.

In this respect, each induction heater 122 is arranged to induction heat a region of the first pipe 1 on the same side of the gap 15 as the first pipe 1.

Each induction-heater 122 is arranged to heat section of the pipe 1 that is outside, and longitudinally adjacent to, the heat affected zone. It will be appreciated that the region outside of the heat affected zone is commonly referred to in the art as the ‘base material’.

Pre-heating the region outside of the heat affected zone may reduce the temperature gradient, across the pipe 1, caused by the laser beam welding, thereby reducing the rate of cooling, following the welding. Accordingly this may reduce an undesirable change in material properties that would otherwise occur during the post-welding, as with the previous embodiment.

It will be appreciated that, alternatively, the induction heating wire 125 may be located entirely on the same side of the yap 15 as the second pipe 2.

In the currently described embodiment, the induction heaters 122 only heat the first pipe 1 and not the second pipe 2. Alternatively, each induction heater 122 may be arranged to heat both of the pipes 1, 2. In this case, in addition to the heating of the first pipe 1, that the induction heater 122 is mounted on, there may be some inevitable induction heating of the second pipe 2, in the region on the other side of the gap 15, due to the magnetic field of the induction heater 122 extending into the other pipe 2.

A further difference of the currently described embodiment, compared to the previous embodiment, is that the induction heater 22 arranged to perform ‘induction post-heating’, i.e. the induction heater 22 that follows the laser beam welder 31, has been replaced with a conduction heater 150.

As with the induction heater 22 arranged to perform induction post heating, the conduction heater 150 comprises a carriage 123 that travels in the same way along the track 119 to follow the laser beam welder 131.

The conduction heater 150 has the same function of ‘post-heating’, following the welding, but does this by conduction heating of the pipe 1, instead of by induction heating. In this regard, the conduction heater 150 comprises an electrical conductive wire (not shown) in contact with said region of the first pipe 1, such that when an electric current is passed through the wire, the wire heats up and heats the pipe 1 by conduction.

The conduction heater 150 is arranged to heat a region of the first pipe 1 on the same side of the gap 15 as the first pipe 1, that extends circumferentially behind the laser beam welder 31, after the laser beam welder 31 welds the opposed end surfaces 11, 12 of that region together. This ‘conduction post-heating’ further reduces the rate of cooling of the pipe 1 following the welding.

It will be appreciated that alternatively, or additionally, the conduction heater 150 may be arranged to heat the second pipe 2.

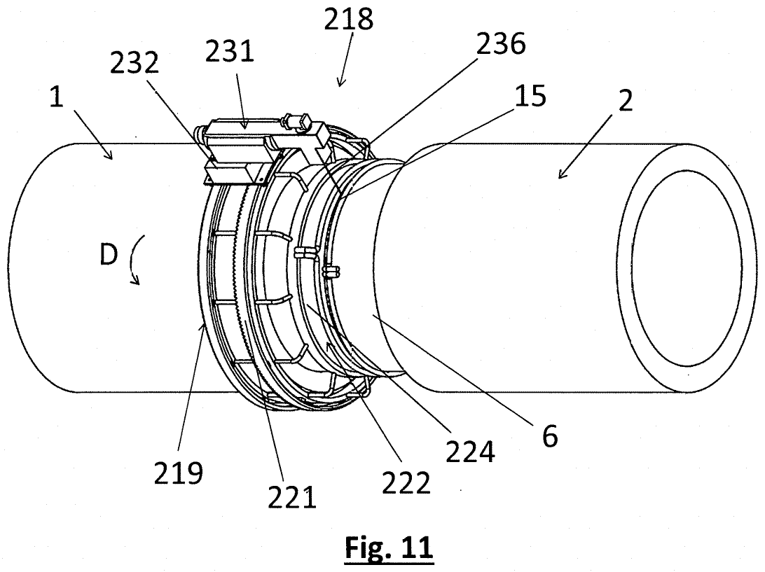

Referring to FIG. 11 there is shown a view corresponding to that of FIG. 4 but where the welding apparatus 218 is according to a further embodiment of the invention.

In FIG. 11 the pipes 1, 2 and welding apparatus 218 are identical to those in FIGS. 1 to 5, except for the differences described below. Corresponding features of the pipes 1, 2 are given corresponding reference numerals. Corresponding features of the welding apparatus are given corresponding reference numerals hut incremented by 200.

The welding apparatus 218 is identical to the welding apparatus 18 of the first described embodiment except in that the induction heaters 22 have been replaced with a single annular induction heater 222 that is mounted on the end 5 of the first pipe 1 and extends around the circumference of the end 5 of the pipe 1.

The induction heater 222 is arranged to heat, by induction heating, the entire circumference of a region of the pipe 1 adjacent to the gap 15. The induction heater 222 is arranged to heat this section of the pipe 1 uniformly across its circumference.

The induction heater 222 comprises an annular housing 224, within which is provided annular induction heating wires (not shown) that are arranged to heat said circumferential section of the pipe 1.

The induction heater 222 is arranged to heat said circumferentially extending section of the pipe 1 as the laser beam welder 31 travels around the pipes 1, 2, welding the end surfaces together.

Accordingly, the induction heater 222 performs the ‘induction pre-heating’ and ‘induction post-heating’ functions of the induction heaters 22 of the first described embodiment of the welding apparatus 18.

As with the previously described embodiment, the induction heater 222 is arranged to heat a region of the pipe 1 that is outside, and longitudinally adjacent to, the heat affected zone.

It will be appreciated that, alternatively, the induction heater 222 may be arranged to heat a region of the second pipe 2 adjacent to the gap 15.

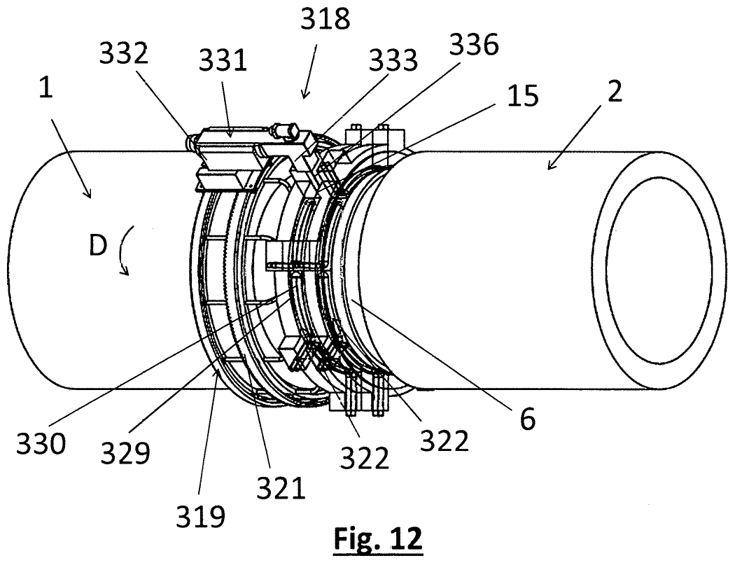

Referring to FIG. 12 there is shown a view corresponding to that of FIG. 4 but where the welding apparatus 318 is according to a further embodiment of the invention.

In FIG. 12 the pipes 1, 2 and welding apparatus 318 are identical to those in FIGS. 1 to 5, except for the differences described below. Corresponding features of the pipes 1, 2 are given corresponding reference numerals. Corresponding features of the welding apparatus are given corresponding reference numerals but incremented by 300.

The welding apparatus 318 is identical to the welding apparatus 18 of the first described embodiment except in that the induction heaters 322 are a plurality of pairs of induction heaters 322, circumferentially distributed around the ends 5, 6 of the pipes 1, 2.

The induction heaters 322 of each pair are aligned in the circumferential direction and are positioned longitudinally adjacent to each other, extending across the gap 15.

Each induction heater 322 in a pair is arranged to induction heat a region of the respective pipe 1, 2 on a respective side of the gap 15. The induction heaters 322 are arranged to heat the heat affected zone.

The induction heaters 322 are mounted on the pipes such that they are stationary on the pipes 1, 2, i.e. they do not travel circumferentially relative to the pipes 1, 2.

Each induction heater 322, in a respective pair, is only on when the laser beam welding head 333 is local to the induction heater 322, i.e. at or near the heater 322, so as to perform the induction pre-heating.

Once the laser beam welding head 333 has passed the induction heater 322, and is remote from the heater 322, the heater 322 is turned off. This advantageously only pre-heats the sections of the pipes when necessary, thereby providing a relatively efficient means of pre-heating the pipes.

Alternatively each induction heater 322 may remain on, once the laser beam welding head 333 passes the induction heater 322, and is remote from the heater 322, to heat regions of the pipes after the welding.

As a further option, the induction heaters 322 may be arranged to move around the respective pipes 1, 2, each induction heater 322 being turned on or off in dependence on the circumferential position of the laser beam welding head 333 relative to the induction heater 322. The induction heater 322 may be fixed or stationary.

In each of the described embodiments the pipes 1, 2 may, alternatively or additionally, be rotated about the longitudinal axis X, to provide for relative movement of the induction heaters and/or laser beam welder relative to the pipes 1, 2, for example where the welding apparatus is used to weld together two pipe lengths, to form a pipe section.

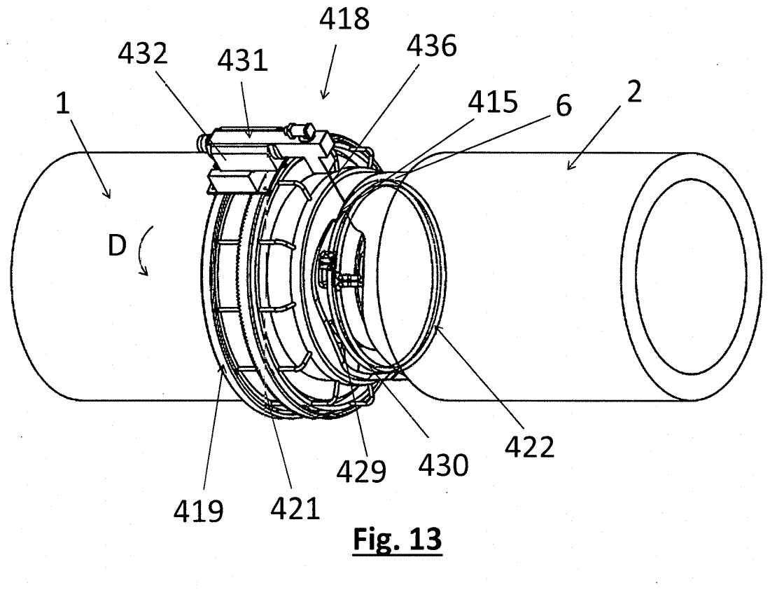

Referring to FIG. 13 there is shown a view corresponding to that of FIG. 4 but where the welding apparatus 418 is according to a further embodiment of the invention.

In FIG. 13 the pipes 1, 2 and welding apparatus 418 are identical to those of the embodiment shown in FIG. 11, except for the differences described below. Corresponding features of the pipes 1, 2 are given corresponding reference numerals. Corresponding features of the welding apparatus are given corresponding reference numerals but incremented by 200 (relative to the reference numerals in FIG. 11).

The embodiment of the welding apparatus 418 shown in FIG. 13 is identical to the welding apparatus 218 shown in FIG. 11 except in that the single, annular induction heater 422 is mounted on the inside of the pipes 1, 2, i.e. radially inwardly of the annular walls of the pipes 1, 2. In this regard, the induction heater 422 is arranged to heat the same regions of the pipes 1, 2 as the FIG. 11 embodiment, but from inside the pipes 1, 2.

Any of the above described embodiments of the welding apparatus may have their induction heater(s) positioned inside the respective pipes 1, 2, arranged to heat the, or each, pipe 1, 2 from the inside.

Any of the above described embodiments of the welding apparatus may be used in the above described method of laser beam welding, in the same way described so as to provide the induction pre-heating, and optionally post-heating, of one or both of the pipes 1, 2.

Any of the above described embodiments of methods of laser beam welding, and any of the above described embodiments of welding apparatus, may be used to weld any of the different versions of the pipes 1, 2 shown in FIGS. 1 to 14, i.e. with the different arrangement of spacer(s) (or nor spacer).

The above described embodiments of the apparatus and method of the invention may be for welding an underwater pipeline, for example.

As described above, the welding apparatus and method of welding is particularly advantageous when used to weld pipes that are subsequently laid as part of an underwater pipeline.

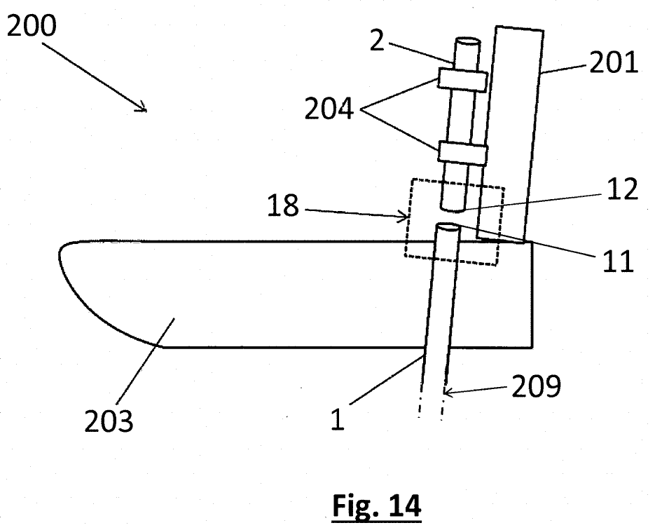

Referring to FIG. 14 there is shown a schematic view of a pipeline construction apparatus 200 according to a further embodiment of the invention.

The pipeline construction apparatus 200 comprises a pipeline laying vessel 203 having a J-lay tower 201 which supports a pipe positioning system 204 and the pipe welding apparatus 18 of the first described embodiment (shown schematically as a dashed rectangle 18). It will be appreciated that the pipe welding apparatus 18 may be replaced with the pipe welding apparatus of any of the above described embodiments.

The pipeline laying vessel 203 is at sea and is configured for J-lay pipeline laying operations. A carbon steel pipe-string 209 extends from the sea bed to the pipeline laying vessel 203. The free end of the pipe-string 209 is identical to the first pipe 1 shown in FIG. 7 and corresponding features are given corresponding reference numerals.

At the pipeline laying vessel 203, the end of the pipe 1 protrudes into the vessel 203 at a substantially vertical orientation; the end of the pipe 1 being held by the clamp (not shown) of the welding apparatus 18.

The J-lay tower 201 is mounted to the deck of the pipeline laying vessel 203 and is configured to support a pipe section 2, in a substantially vertical position above the end of the end pipe 1 of the pipe-string 209, for joining end-to-end with the pipe 1. The pipe section 2 is identical to the second pipe 2 shown in FIG. 7 and corresponding features are given corresponding reference numerals.

It will be appreciated that the end pipe 1 and the pipe section 2 may be any of the above described versions of the first and second pipes 1, 2.

The pipeline construction apparatus 200 is used to carry out a method of constructing a pipeline according to a further embodiment of the invention, as will now be described.

The pipe section 2 is held by a pipe positioning system 204 comprising a clamp assembly controllable via a corresponding actuator assembly which is mounted to the J-lay tower 201 to move the pipe section 2 into the position shown in FIG. 7, so that said gap 15 is provided between the opposed surfaces 11, 12 of the pipes 1, 2. The above described respective method of welding is then performed, by the welding apparatus 18, to weld the opposed surfaces 11, 12 of the pipes 1, 2 together.

The pipe section 2 that has been welded to the end of the pipe-string 1 is then deployed into an underwater position, at a relatively large depth, to form part of an underwater pipeline.

Alternatively, or additionally, the S-lay method and/or tow-in method may be used to deploy the pipe string to its underwater position. These methods of pipe laying are known in the art and therefore will not be descripted in any further detail.

The above described method and apparatus for constructing a pipeline may be used with any of the described embodiments of methods of welding two pipes 1, 2 together, with any of the described pipes 1, 2 and with any of the above described embodiments of welding apparatus.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

In each of the described embodiments, the induction heaters may be arranged to heat inside and/or outside the heat affected zone.

In each of the described embodiments, the inductions heaters may be arranged to heat one or both of the pipes 1, 2.

In the described embodiments, the welding apparatus is mounted on the pipe 1 after the pipes 1, 2 have been positioned to provide the gap 15. However, the welding apparatus 18 may be mounted on the pipe 1 (and/or the pipe 2) before the pipes 1, 2 have been positioned to provide the gap 15.

In the described embodiment the gap 15 is annular and extends substantially around the longitudinal axis X. The gap 15 may extend in the axial and/or radial direction.

A plurality of said gaps 15 may be provided between the opposed surfaces 11, 12 of the pipes 1, 2. Each gap may be provided between respective opposed sections of the opposed surfaces 11, 12. It will be appreciated that, in this case, each of the opposed sections are welded to each other by the laser beam welding. The plurality of gaps may be distributed in the circumferential and/or radial direction.

One or both of the opposed surfaces 11, 12 may have a rough surface such that when discrete sections of the opposed surfaces 11, 12 are in contact, other discrete sections are spaced apart by respective gaps.

The welding apparatus 18 may comprise different arrangements of the induction heaters 22 and laser beam head 33.

In this regard, the welding apparatus 18 may comprise a different number of induction heaters 22 used to pre-heat the pipes 1, 2 and, for example, may only include a single induction heater 22. It will be appreciated that, in this case, the single induction heater 22 may be arranged to travel circumferentially substantially around the longitudinal axis X.

Different numbers of induction heaters 22 used to induction post-heat the pipes 1, 2 may be used. Furthermore, the induction heater 22 used to post-heat the pipes 1, 2 may be omitted. Alternatively, or additionally, the post-heating may be performed by one or more different types of heater, including a conduction heater.

The laser beam welding may be laser-hybrid welding. In this respect, the laser beam welding may be performed in conjunction with gas metal arc welding (e.g. semi-automatic gas metal arc welding).

One or both of the pipes 1, 2 may be heated, by the induction heating, before the pipes 1, 2 are arranged such that the gap 15 is provided between their opposed surfaces 11, (in addition to the induction heating that occurs while the pipes 1, 2 are separate by the gap 15). However, preferably the pipes 1, 2 are arranged such that the qap 15 is provided between their opposed surfaces before the pipes are heated by the induction heating.

The induction heating of the pipes 1, 2 may continue during the laser beam welding. However, preferably the induction heating is stopped before the laser beam welding is started.

It will be appreciated that features described in relation to one embodiment of the present invention may be incorporated into other embodiments of the present invention. For example, the method of any embodiment of the invention may incorporate any of the features described with reference to the apparatus of any embodiment of the invention and vice versa.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A method of laser beam welding two pipes together, the method comprising the steps of
arranging two pipes such that a gap is provided between opposed surfaces of the pipes,
heating at least one of the pipes by induction heating while the gap is provided between the opposed surfaces of the pipes,
and subsequently laser beam welding the opposed surfaces of the pipes together.

2. A method according to claim 1 wherein the gap has a length, in the axial direction, that is less than or equal to 0.5 mm.

3. A method according to claim 1 wherein the opposed surfaces are spaced apart by a spacer, to provide the gap.

4. A method according to claim 3 wherein a pipe is provided with the spacer.

5. A method according to claim 4 wherein the spacer is attached to, or integrally formed with, the pipe.

6. A method according to claim 3 wherein the spacer is part of a pipe.

7. A method according to claim 3 wherein each pipe is provided with a respective said spacer.

8. A method according to claim 7 wherein the gap is provided between the opposed surfaces of the pipes by positioning the pipes such that the spacers are in abutment with each other.

9. A method according to claim 3 wherein during the laser beam welding the, or each, spacer forms part of the weld.

10. A method according to claim 3 wherein the opposed surfaces are substantially parallel to each other.

11. (canceled)

12. A method according to claim 1 wherein the heating of the at least one pipe is by a plurality of circumferentially distributed induction heaters and the laser beam welding is by a laser beam head, arranged to travel relative to the pipes in the circumferential direction, wherein each induction heater is turned on or off in dependence on the circumferential position of the laser beam head relative to the induction heater.

13. A method according to claim 1 wherein at least one of the pipes is heated after the welding, so as to reduce the rate of cooling of the pipe.

14. A method according to claim 1 wherein the opposed surface of one or both pipes is machined such that the gap is provided between the opposed surfaces when the pipes are placed in said arrangement.

15. A method according to claim 1 wherein substantially no material is introduced between the opposed surfaces, during the laser beam welding, to form part of the weld.

16. A method according to claim 1 wherein the gap is such that the eddy currents migrate to the opposed surface of the at least one pipe.

17. A method according to claim 1 wherein the gap is an air gap.

18. A method according to claim 1 wherein the pipes are for use underwater.

19. A method according to claim 1 wherein the pipes are for transporting oil or gas.

20. A method according to claim 1 wherein the wall of each pipe has a thickness that is greater than or equal to 10 mm.

21. (canceled)

22. A method of constructing a pipeline comprising laser beam welding two pipes together according to the method of claim 1, to form a pipeline.

23. A method of constructing a pipeline according to claim 22 wherein the pipeline is an underwater pipeline and the method comprises deploying the pipeline into an underwater position.

24. A pipe welding apparatus configured to carry out the method of claim 1.

25. A pipeline construction apparatus configured to carry out the method of constructing a pipeline according to claim 22.

26. A pipe having an end that has been machined such that the pipe is for use in a method of laser beam welding according to claim 3.

27. A combination of first and second pipes that each have an end that has been machined such that the pipes are for being welded together by a method of laser beam welding according to any of claims 3 to 10 claim 3.

28. (canceled)

29. (canceled)

30. A method according to claim 1 wherein substantially no external material is used to form part of the weld.

31. A method according to claim 1 wherein the gap has a length, in the axial direction, that is less than or equal to 0.3 mm.
